(19) United States
(12) Patent Application Publication
(10) Pub. No.: US 2007/0216660 A1
(43) Pub. Date: Sep. 20, 2007

(54) Methods and apparatus to implement electronic whiteboards

(76) Inventors: Steve Sposato, Lafayette, CA (US); Raj Savoor, Walnut Creek, CA (US); Jerold Osato, Pinole, CA (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/384,701

(22) Filed: Mar. 20, 2006

(51) Int. Cl. G06F 3/041

(52) U.S. Cl. 345/173

(57) ABSTRACT

Methods and apparatus to provide electronic whiteboards are disclosed. An example apparatus includes a housing, a display in the housing for presenting at least one of stored information or received information, a memory in the housing to store information associated with the electronic whiteboard, and an authenticator in the housing to analyze biometric data to identify the user.

### FIELD OF THE DISCLOSURE

The present disclosure relates generally to computer systems and, more particularly, to methods and apparatus to implement electronic whiteboards.

### BACKGROUND

Electronic whiteboards encompass a wide variety of devices that are used to display presentations and enable interactive displays. The use of electronic whiteboards has grown in business use as the benefits of electronic multimedia presentations have been realized. In addition, electronic whiteboards have been introduced in new areas such as in education, advertising, and video conferencing scenarios.

Typically, electronic whiteboards comprise a display device (e.g., monitor, projector and screen, television, etc.) connected to an external computer (e.g., desktop computer, laptop computer, etc.). The computer transmits images that are to be displayed on the display device. The display device returns user input information received from users of the electronic whiteboard. For example, many electronic whiteboards allow a user to write or draw on the surface of the display device using a dry erase marker. As the user draws on the surface of the display device, the display device transmits the information to the external computer. The external computer records the user's drawing or writing so that the presentation can later be printed with the markings overlaid on the presentation.

### BRIEF DESCRIPTION OF THE DRAWINGS

FIG. 1 is a block diagram of an example implementation of an electronic whiteboard.

FIG. 2 is a block diagram of an example communications system.

FIG. 3 is a block diagram of example circuitry for implementing the first electronic whiteboard (EW) and/or the second EW of FIG. 1.

FIG. 4 is an illustration of several writing strokes that comprise the text on the apparatus of FIG. 1.

FIG. 5 is a table representative of an example data structure that stores vectors associated with writing strokes.

FIG. 6 is a flowchart representative of example machine readable instructions which may be executed to authenticate users and receive user input at the apparatus of FIG. 1.

FIG. 7 is a flowchart representative of example machine readable instructions which may be executed to implement the task list of the apparatus of FIG. 1.

FIG. 8 is an example processor system that may execute the machine readable instructions represented by FIGS. 6 and/or 7 to implement the example methods and apparatus described herein.

### DETAILED DESCRIPTION

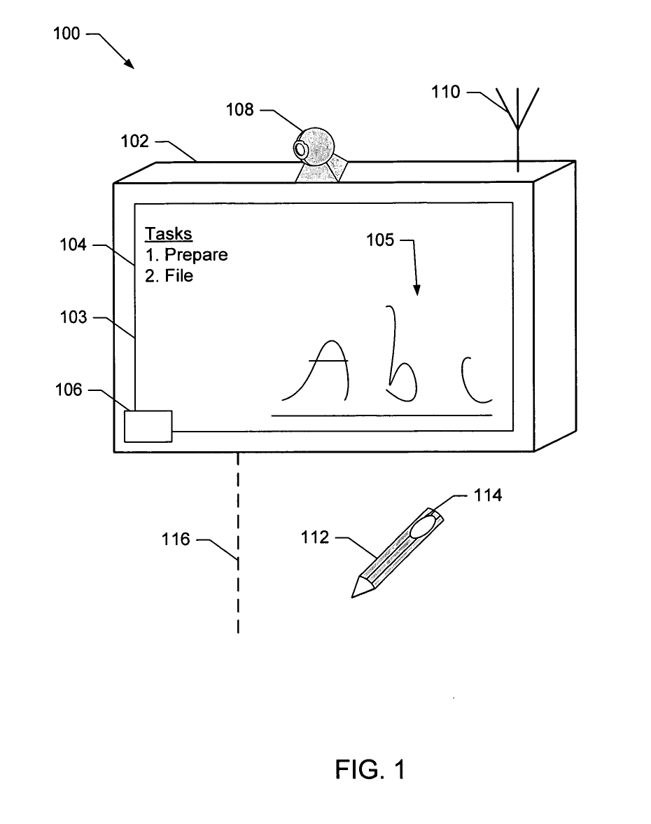

An example apparatus 100 is illustrated in FIG. 1. The example methods and apparatus described herein may be used to implement an electronic whiteboard (EW). In general, the example methods and apparatus use biometric characteristics of a user to authenticate the user and to associate stored user input information with the user. In addition, the example methods and apparatus enable an electronic whiteboard to transmit and receive live user input information and stored user input information to/from various display devices (e.g., personal digital assistants (PDAs), computers, televisions, other EWs, etc.)

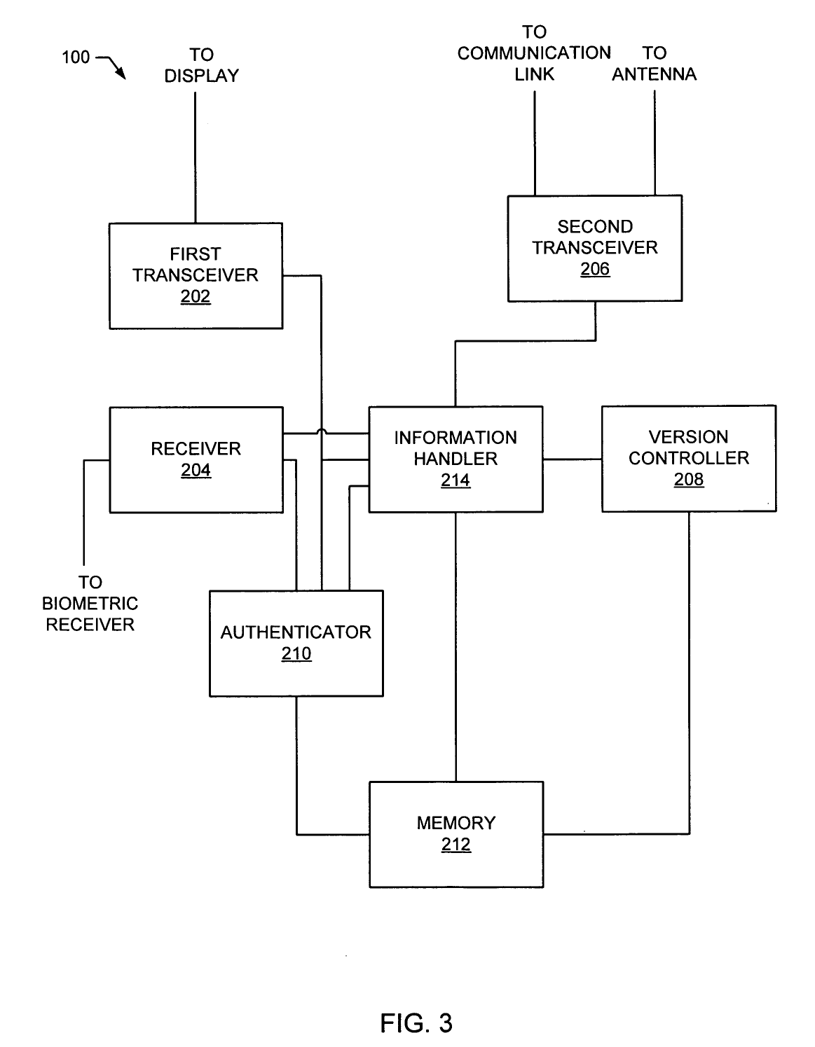

The example apparatus 100 illustrated in FIG. 1 is an example implementation of an electronic whiteboard. The example apparatus includes a housing 102, a display 103, an input receiver 106, a camera 108, an antenna 110, a first user input device (UID) 112, and a communication link 116. In addition, the example apparatus comprises a processing system (not shown in FIG. 1) that is described in further detail in conjunction with FIG. 3. In the example apparatus of FIG. 1, an example task list 104 and example text 105 is displayed in the display 103.

In the example apparatus 100, the housing 102 encloses the components of the example apparatus 100. In addition, some components of the example apparatus 100 are attached to the exterior of the housing 102. The housing may be made of any material such as, for example, plastic, metal, wood, or any other material. While the housing 102 may begin as an empty frame having components added thereto, the housing 102 may alternatively be a case associated with one of the components for the example apparatus 100. For example, the housing 102 may be the case of the display 103.

In the example apparatus 100, the display 103 acts as a receiver for user inputs. In the example, the display 103 displays images and/or text in response to inputs from a user of the example apparatus 100. For example, a user may use the first UID 112 to add a task to the task list 104 and/or to write text 105 on the display 103. As the user moves the first UID 112 across the display 103, the display 103 receives input(s) from the first UID 112 to enable the example apparatus 100 to track the movement of the UID 112. The apparatus 100 outputs information to the display 103 corresponding to the input from the user. For example, as illustrated by the text 105, when the user writes ‘Abc’ on the display 103, the apparatus 100 outputs markings corresponding to the locations where the user wrote on the display 103. In alternate implementations, the display 103 may not include the capability to receive user input. Rather, the apparatus 100 may include a separate receiver that tracks the location of the first UID 112, and/or the first UID 112 may transmit messages to the example apparatus 100 to indicate the location of the first UID 112. For example, the UID 112 may only transmit data when a switch associated with the tip of the UID 112 is closed by, for example, pressing the tip against a surface.

The display 103 may additionally display text on the display 103 received from devices other than the UID 112. For example, the example apparatus 100 may cause a task list 105 to be displayed on the display 103. The text (e.g., task list 104) may be received from a computer or another electronic whiteboard. In addition, the example apparatus 100 may receive writing from the first UID 112 and may convert the input writing into computer generated text (e.g., American Standard Code for Information (ASCII) text) using a hand-writing recognition algorithm.

In the example communications system 100, the display 103 comprises a low power display that does not require backlighting. For example, the display 103 may comprise an electronic paper display, an organic light emitting diode (OLED) display, surface-conduction electron-emitter display (SED), any vacuum deposited organic electronic components display, or any other display technology. However, in some instances, power consumption may not be a concern and/or lower power displays may not be desirable. In these instances, other electronic whiteboard display's may be used such as, for example, plasma displays, liquid crystal displays (LCDs), rear-projection displays, front-projection displays, CRT displays, displays requiring backlighting, or any other available display technology.

The task list 105 displays task items on the display 103. Task items may include information such as a title for the task, a person assigned to complete the task, the current status of the task, a deadline associated with the task, a priority associated with the task, instructions for completing the task, etc. The task items may be input by a user at the apparatus 100 (e.g., task items may be input using the UID 112 or any other user input device associated with the apparatus 100). Additionally or alternatively, the apparatus 100 may receive task items from another EW or a computer. The task list 105 may indicate the location where the task items were input. The task list 105 may sort the task list in any order such as, for example, in order by deadline date, priority, project affiliation, the date the task item was input, the person assigned to the task item, etc. In addition, the task list 105 may highlight tasks, change the font color of tasks, display symbols or graphics associated with tasks, etc.

The example input receiver 106 shown in FIG. 1 is a biometric receiver that receives physical characteristic information from users of the example apparatus 100. The input(s) from the input receiver 106 are used by the apparatus 100 to determine the identity of a user of the apparatus 100. For example, when the example input receiver 106 receives some physical characteristic information, the apparatus will compare the received information with previously stored information to identify the user and/or to take certain actions associated with the identified user (e.g., to determine if the user is authorized to access the apparatus 100, to load personalized settings for the user, to associate inputs such as writing with the user, etc.)

The input receiver 106 of the illustrated example may be any biometric receiver such as, for example, a microphone, a fingerprint reader, a retina scanner, a handprint reader, a proximity sensor, a deoxyribonucleic acid (DNA) receiver, etc. The input receiver 106 may additionally or alternatively receive information other than biometric information. For example, the input receiver 106 may communicate with and/or receive input from radio frequency identification chips (RFIDs), may read a barcode, may read a magnetic stripe card, or may use any other receiver technology to receive input from users. The received input may or may not identify the user.

While the example apparatus 100 illustrated in FIG. 1 includes only one input receiver 106, persons of ordinary skill in the art will recognize that the example apparatus 100 may include any number and/or type of input receivers as desired.

The camera 108 is used by the apparatus 100 to recognize the identity of users based on physical appearance and/or for use in video conferencing. For instance, the apparatus 100 of the illustrated example compares images or video received from the camera 108 to previously stored information to identify the user in an image captured by the camera and take certain action(s) based on that identification (e.g., to determine if the identified individual is authorized to access the apparatus 100, to load personalized settings for the identified user, to associate input such as writing with the identified user, etc.) Additionally or alternatively, images or video content captured by the camera 108 may be displayed on the display 103 and/or transmitted to a computer, another EW, or to any other display device. Accordingly, the camera 108 enables the first EW 102 to participate in a video conference session. For example, video received from the camera may be transmitted to a second EW for display and, conversely, video from the second EW may be displayed on the display 103 of the example apparatus 100.

In the example of FIG. 1, the example apparatus 100 includes the antenna 110. The antenna 110 of the illustrated example is connected to wireless communication circuitry associated with the apparatus 100. Thus, the antenna 110 enables the apparatus 100 to send to and receive data from other EWs, computers, or any other broadcast source. For example, the antenna 110 may be connected to communication circuitry operating in accordance with the IEEE 802.11g protocol for wireless networking communication. Persons of ordinary skill in the art will recognize that the antenna 110 may be associated with any type of wireless communication circuitry such as, for example, Bluetooth circuitry, any variety of IEEE 802.11 protocol circuitry, Code Division Multiple Access (CDMA) circuitry, Global System for Mobile Communication (GSM), General Packet Radio Service (GPRS) circuitry, universal mobile telecommunications system (UMTS) circuitry, or any other wireless communications circuitry.

The first UID 112 of the illustrated example is a light (e.g., ultraviolet, infrared, light amplification by stimulated emission of radiation (LASER), etc.) pen that enables a user to input data and instructions to the first EW 102 by writing with the pen. The first UID 112 may be activated when the first UID 112 is pressed against the EW 102. If, for example, the display 103 is an OLED display, the display may alternately power LEDs for display and utilize LEDs as photosensitive diodes. Accordingly, when the first UID 112 is placed near the display 103, the individual diodes of the display 103 can inform the apparatus 100 of the location of the first UID 112. Of course, any other method may be used for receiving user input associated with the first UID 112. For example, the display 103 may be pressure sensitive and the first UID 112 may be used to exert pressure on the display 103.

The first UID 112 may additionally or alternatively include wireless communication circuitry to enable the first UID 112 to communicate with the example apparatus 100 or with any other EW or computer. For example, the first UID 112 may utilize wireless communication circuitry to send data to and receive data from the apparatus 100. Any available wireless communication circuitry such as, for example, communication circuitry operating in accordance with the Bluetooth protocol, may be used for this purpose. The first UID 112 may communicate with communication circuitry attached to any of the antenna 110, the input receiver 106, a dedicated transceiver of the apparatus 100 associated with the first UID 112, or any other receiver, transmitter, or transceiver.

The first UID 112 of the illustrated example includes a biometric receiver 114. The biometric receiver 114 receives biometric information from a user. In the illustrated example, the biometric information is transmitted to the apparatus 100 using wireless communication circuitry. The apparatus 100 compares the biometric information received from the UID 112 with previously stored biometric information to determine the identity of the user in possession of the first UID 112. For example, the biometric receiver 114 may be a fingerprint reader. In such an example, a user of the apparatus 100 is expected to press their finger on the fingerprint reader prior to using the first UID 112 to provide user input to the apparatus 100. In another example, the biometric receiver 114 may be a RFID receiver or transceiver that communicates with an RFID associated with a user of the apparatus 100. Accordingly, the apparatus 100 is able to authenticate the user and associate user input with the user. Persons of ordinary skill in the art will appreciate that a fingerprint reader is but one of many types of biometric receiver 112 and the biometric receiver 114 may be implemented by any type of biometric receiver.

The communication link 116 of the illustrated example is a network connection for connecting the apparatus 100 with another device (e.g., a computer and/or another electronic whiteboard). Thus, the communication link 116 enables the apparatus 100 to send data to and receive data from another device. The communication link 116 may be any type of communication link such as, for example, an Ethernet link, a serial communication link, an IEEE 1394 Firewire communication link, a universal serial bus (USB) communication link, a power line communication link, a power over ethernet (POE) communication link, etc. While the communication link 116 is illustrated in the example of FIG. 1 as a direct connection, additional components may be included. For example, the communication link may include one or more network hubs, one or more network switches, one or more network routers, etc. Persons of ordinary skill in the art will recognize that the apparatus 100 may not include the communication link 116 when communication with other devices is not desired. For example, the communication link 116 may be representative of the communicative link between the apparatus 100 and another device via the antenna 120.

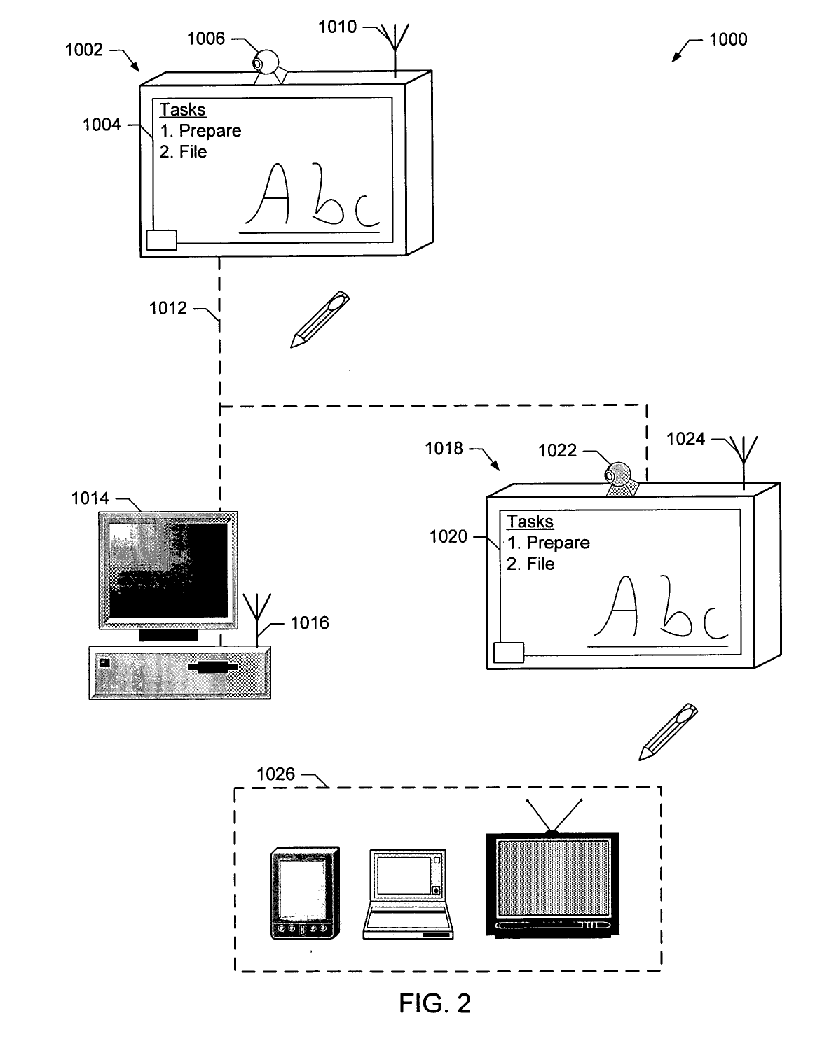

FIG. 2 is a block diagram of an example communication system. The example communication system comprises a first EW 1002, a communication link 1012, a computer 1014, a second EW 1004, and one or more display devices 1026. The first EW 1002 and the second EW 1020 include components similar to the apparatus 100 of FIG. 1 and, thus, the components are not described in further detail herein.

Computer 1014 is a computer in communication with the first EW 1002. The computer 1014 includes antenna 1016 for wireless communication. The computer 1014 transfers data to and receives data from the first EW 1002. For example, the computer 1014 may store a presentation that is transferred to the first EW 1002 for presentation. The first EW 1002 may receive user comments or changes for the presentation which may be transferred to the computer 1014 for storage. The computer 1014 may be any type of computer including, for example, a server, a desktop computer, a laptop, a handheld computer, etc.

The antenna 1016 of the illustrated example is similar to the antenna 110 connected to the first EW 102. The antenna 1016 of the illustrated example is connected to wireless communication circuitry associated with the computer 1014. The antenna 1016 enables the computer 1014 to send and receive data to/from EWs, computers, or any other receive and/or broadcast source. For example, the antenna 1016 may be connected to communication circuitry operating in accordance with the IEEE 802.11g protocol for wireless networking communication. Persons of ordinary skill in the art will recognize that the antenna 1016 may be associated with any type of wireless communication circuitry such as, for example, Bluetooth circuitry, any variety of IEEE 802.11 protocol circuitry, Code Division Multiple Access (CDMA) circuitry, Global System for Mobile Communication (GSM), General Packet Radio Service (GPRS) circuitry, or any other wireless communications circuitry. Persons of ordinary skill in the art will recognize that the apparatus 100 may not include the antenna 120 when communication with other devices is not desired.

The communication link 1012, which may be similar to the communication link 116 of FIG. 1, communicatively couples the first EW 1002 with the computer 1014 and the second EW 1018. The communication link 1012 enables data to be transferred between the first EW 1002 and the computer and the first EW 1002 and the second EW 1018. In addition, the communication link 1012 may enable data to be transferred between the computer 1014 and the second EW 1018. For example, the communication link 1012 may enable task items, user input, video conferencing content, audio content, etc. to be transferred. Additionally or alternatively, the communication link 1012 may communicatively couple the first EW 1002 and the one or more display devices 1016.

In addition to or as an alternative to communicating via the communication link 1012, two or more of the first EW 1002, the computer 1014, the second EW 1018, and the one or more display devices 1026 may communicate wirelessly. For example, the first EW 1002, the computer 1016, and the second EW 1018 include antennas 1010, 1016, and 1024 which may be similar to the antenna 110 of FIG. 1.

In the illustrated example, computer 1014 is a computer in communication with the first EW 1002. The computer 1014 transfers data to and receives data from the first EW 124. For example, the computer 1014 may store a presentation that is transferred to the first EW 124 for presentation. The first EW 124 may receive user comments or changes for the presentation which may be transferred to the computer 1014 for storage. The computer 1014 may be any type of computer including, for example, a server, a desktop computer, a laptop, a handheld computer, etc.

The one or more display devices 1026 of the illustrated example may be implemented by any number or variety of devices that may be used to display information received from the first EW 1002, the second EW 1018, and/or the computer 1014. The one or more display devices 1026 may include one or more of, for example, a PDA, a laptop computer, a desktop computer, a television, a projector, an LED display, a video equipped cellular phone, a video equipped land-line phone, a portable video display device, etc. The one or more display devices 1026 may communicate with the first EW 1002, the second EW 1018, and/or the computer 1014 using wired or wireless communications (not shown). For example, the first EW 1002 may broadcast an image or video using the antenna 1010 that is received by the display device(s) 1026. The display device(s) 1026 will receive the image or video and display the image or video on the associated display. The display device(s) 1026 may additionally be capable of transmitting user input to the first EW 1002, the second EW 1018, and/or the computer 1014. For example, the display device(s) 1026 may transmit text input from a user to the first EW 1002.

The communication system 1000 enables the first EW 1002 and the second EW 1018 to share a task list. Task items entered at either of the first EW 1002 and the second EW 1018 may be displayed in a task list 1004 on the first EW 1002 and a task list 1020 on the second EW 1018. In addition, task items may be labeled according to display preference. For example, certain items may be shared and displayed at both the first EW 1002 and the second EW 1018 while other items may only be displayed at one of the first EW 1002 or the second EW 1018. In addition, task items may be labeled with symbols, colored text, highlighting etc. according to the location where the task items were entered. In addition to the forgoing example, the computer 1014 and/or the one or more display devices 1026 may additionally store, display, transmit, and receive input from users associated with task items.

The communication system 1000 enables the first EW 1002 and the second EW 1018 to engage in teleconferencing. For example, audio, images, and/or video content received from the camera 1006 at the first EW 1002 may be transmitted to the second EW 1018 and audio, images, and/or video content received from the camera 1022 at the second EW 1018 may be transmitted to the first EW 1002. The images and/or video content may be displayed on all or part of the display portion of the first EW 1002 and the second EW 1018. In addition, a presentation may be shared between the first EW 1002 and the second EW 1018 and may be displayed on part of the display portion of the first EW 1002 and the second EW 1018. Audio may be presented using a speaker that is included in the first EW 1002 and/or the second EW 1018 and/or externally attached to the first EW 1002 and/or the second EW 1018. In addition to the forgoing example, the computer 1014 and/or the one or more display devices 1026 may additionally transmit and/or receive videoconferencing content from the first EW 1002 and/or the second EW 1018.

FIG. 3 is a block diagram of an example circuit for implementing the apparatus 100. For ease of description, the block diagram of FIG. 3 will be referred to as the apparatus 100.

The example implementation of the apparatus 100 shown in FIG. 3 includes a first transceiver 202, a receiver 204, a second transceiver 206, a version controller 208, an authenticator 210, a memory 212, and an information handler 214.

The first transceiver 202 of the illustrated example receives input from the display 103 of the first apparatus 100 and outputs information to be display on the display 103. For example, when the user “writes” their signature on the display 103, the location of the user's signature writing is received by the first transceiver 202. The first transceiver 202 transmits user input received from the display 103 to the information handler 214 and/or the authenticator 210. The first transceiver 202 also receives information from the information handler 214.

The receiver 204 of the illustrated example receives input from the biometric receiver 106 of the apparatus 100. The receiver 204 transmits the received input(s) to the information handler 214 and/or the authenticator 210. In addition, the receiver 204 may receive information from the information handler 214. For example, the receiver 204 may receive information from the information handler 214 and/or the authenticator 210 indicating that information received from the biometric receiver 106 was properly authenticated. If the biometric authenticator 106 includes a display, the display may indicate that the authentication was successful.

The second transceiver 206 of the illustrated example is communication circuitry for handling communication with other EWs and computers. The second transceiver 206 may be connected to either or both of the communication link 116 and/or the antenna 110. The second transceiver 206 of the illustrated example receives information from and transmits information to the information handler 214. The second transceiver 206 may be a wireless network communication circuit (e.g., Bluetooth circuitry, any variety of IEEE 802.11 protocol circuitry, CDMA circuitry, GSM, GPRS circuitry, or any other wireless communications circuitry) and/or a wired communication circuit (e.g., an Ethernet link, a serial communication link, an IEEE 1394 Firewire communication link, a USB communication link, or any other communication circuitry).

The version controller 208 of the illustrated example receives information from the information handler 214 and stores the information in the memory 212. The version controller 208 also receives requests for information from the information handler 214 and retrieves the requested information from the memory 212. The version controller 208 stores information in a manner that allows multiple versions of the same data to be stored and retrieved from the memory 212. For example, the version controller 208 may retrieve a first version of a stored presentation. The information handler 214 may modify the presentation and transmit it to the version controller 208 for storage. The version controller 208 then stores a second copy of the presentation and labels it as the next consecutive version number.

To handle information storage, the example version controller 208 of FIG. 3 stores additional characteristic attributes with information that is stored in the memory 212. For example the characteristic attributes may include, a serial number associated with the information, a filename associated with the information, the date the information was created, the date the information was last modified, a version number associated with the information, a user identifier associated with the information (e.g., a user identifier associated with the user that created the information and/or a user identifier associated with the user that last modified the information), etc. The additional characteristic information may be obtained from the information handler 214 and/or the memory 212. For example, the authenticator 210 may authenticate a user before the user is permitted to makes changes to a piece of information. The information handler 214 of the illustrated example receives the user identification information associated with the user from the authenticator 210 and transmits the user identification information to the version controller 208. In a second example, the version controller 208 may receive a list of changes made to the presentation (e.g., a circle drawn in one part of the presentation and text written on another part of the presentation). The version controller 208 of the illustrated example stores each of the changes individually (e.g., it stores vectors associated with each individual change) so that any changes may be retrieved or undone at any time. In addition, the version controller 208 of the illustrated example stores attributes (e.g., associated user identification information) with each of the changes.

Persons of ordinary skill in the art will recognize that the forgoing description of implementations of the version controller 208 is not exhaustive and that any other implementation may be used. For example, the version controller 208 may store data in a version controlled database that is contained in the memory 212. In addition, the version controller 208 may not be necessary in all implementations of the apparatus 100.

The authenticator 210 of the illustrated example receives information from the first transceiver 202 and the receiver 204. The authenticator 210 compares the received information to information stored in the memory 212 to determine the identity of a user interacting with the apparatus 100. The authenticator 210 of the illustrated example transmits information about the authentication to the receiver 204, the first transceiver 202, and/or the information handler 214. For example, the authenticator 210 may receive biometric information associated with a user's fingerprint from the receiver 204 (e.g., information that was input using the biometric receiver 106 of the apparatus 100). The authenticator 210 compares the biometric information to information stored in the memory 212 to determine if the user is registered. Then, when the user attempts to input information to make changes or to request a presentation, the authenticator 210 determines if the user is authorized to perform the requested function.

The memory 212 of the illustrated example may be implemented by any type of available data storage device. Thus, the memory 212 may be any type of volatile or non-volatile memory such as, for example, flash memory, any type of random access memory (RAM), a hard drive, a floppy disk drive, an optical disk drive, etc. Further, the memory 212 may be an internal memory or an external memory. For example, the memory 212 may be a hard drive built into the apparatus 100 or may be a flash memory that is attached to a USB port included with the apparatus 100. While only one memory 212 is illustrated, it should be understood that the apparatus 100 may include any number of memory devices. For example, the apparatus 100 may include RAM, hard disk memory, and access to an external flash memory drive.

The information handler 214 of the illustrated example sends information to and receives information from one or more of the first transceiver 202, the receiver 204, the second transceiver 206, the version controller 208, the authenticator 210, and the memory 212. The information handler 214 processes received information to handle requests from users of the apparatus 100. For example, when a user of the apparatus 100 requests access to a presentation stored in the memory 212, the information handler 214 receives the request and uses information from the authenticator 210 to determine if the user is authorized to access the presentation. If the user is not authorized to access the presentation, the information handler 214 sends a warning message to the first transceiver 202, which is then displayed on the display 103 of the apparatus 100. If the user is authorized to access the presentation, the information handler 214 requests the presentation from the version controller 208. The information handler 214 transfers the presentation to the first transceiver 202 for display on the display 103 of the apparatus 100.

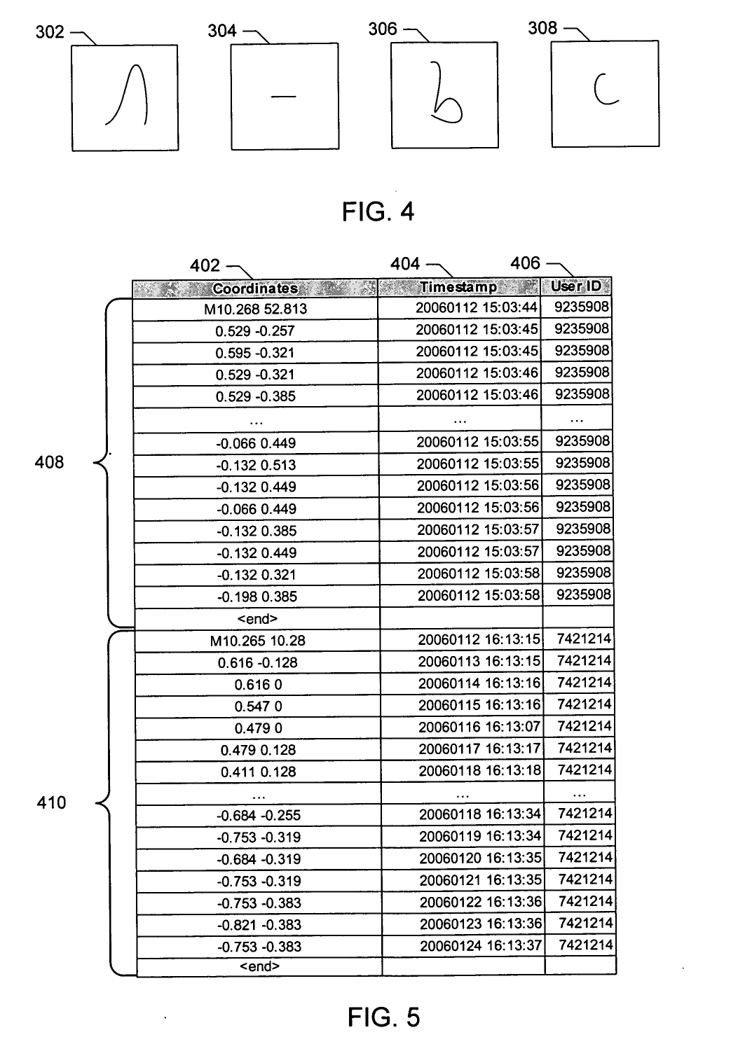

The information handler 214 of the illustrated example additionally handles user input that is to be stored in the memory 212. For example, the information handler 214 may receive one or more vectors associated with a user input. (User input vectors are described in further detail in conjunction with FIGS. 4-5.) The information handler 214 transfers the vectors to the version controller 208 for storage in the memory 212. In addition, the information handler 214 transfers information associated with the vectors (e.g., user identification information associated with the user that provided the user input, the date that the user input was provided, etc.) to the version controller 208. Additionally or alternatively, the information handler 214 may convert the input vectors to computer readable text using hand-writing recognition methods.

FIG. 3 is an illustration of several writing strokes that comprise the text 105 on the first EW 102 of FIG. 1. A first stroke 302 and a second stroke 304 comprise the letter ‘A’, a third stroke 306 comprises the letter ‘b’, and a fourth stroke 308 comprises the letter ‘c’. Each of the strokes 302-308 comprises multiple vectors. By representing user writing as strokes comprised of vectors, the first EW 102 can track individual inputs from a user. Each vector can be stored using the version controller 208. Accordingly, each stroke can be erased or modified if a user desires. Example strokes and vectors are described in further detail below.

FIG. 4 is a table representative of an example data structure that stores vectors associated with user strokes (e.g., the strokes 302-308). The data structure includes a column of coordinates 402, a column of timestamps 404, and a column of user IDs 406.

The example table of FIG. 4 includes an abbreviated set of values 408 for stroke 302 and an abbreviated set of values 410 for stroke 304 of FIG. 3. The first value in the column of coordinates 402 for values 408 indicates the coordinate of the starting point for the stroke. The first value in the column of timestamps 404 indicates the time and date that the stroke was started. The first value in the column of user IDs 406 indicates the user identifier associated with the user that is writing the stroke. The next consecutive row in the example table indicates the attributes of the next point in the stroke. Accordingly, the example table provides a set of points that may be consecutively connected to form the stroke written by the user.

While the example table of FIG. 4 includes a timestamp value and user ID value for each coordinate point in the stroke, other implementations of the table may only include a single timestamp value and user ID value for each stroke because the timestamp and user ID are not likely to change within a stroke. In some example implementations, the timestamp and/or the user ID information is omitted. In addition, while FIG. 4 illustrates a single table, persons of ordinary skill in the art will recognize that multiple tables may be used to store the attributes of the strokes and/or multiple tables may be used to store individual strokes.

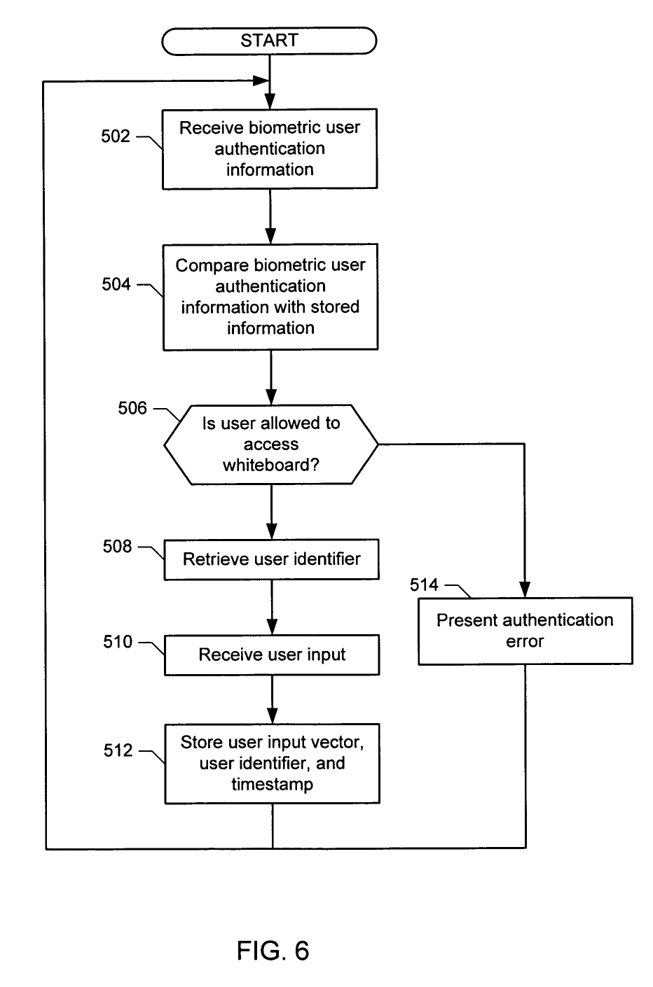

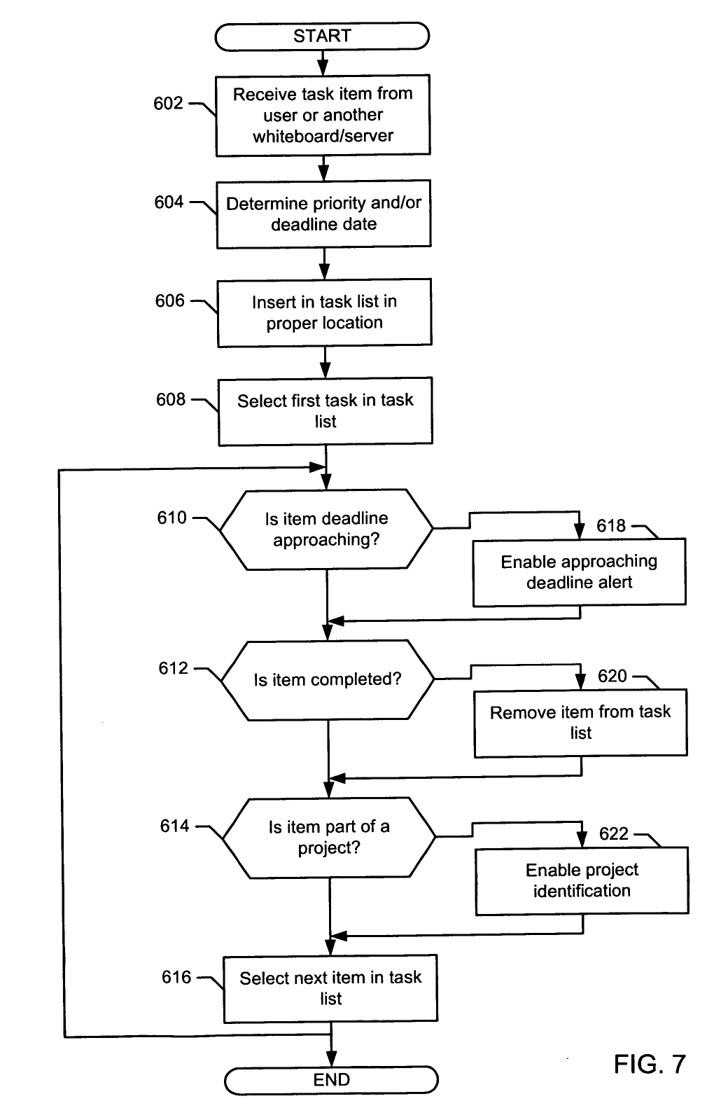

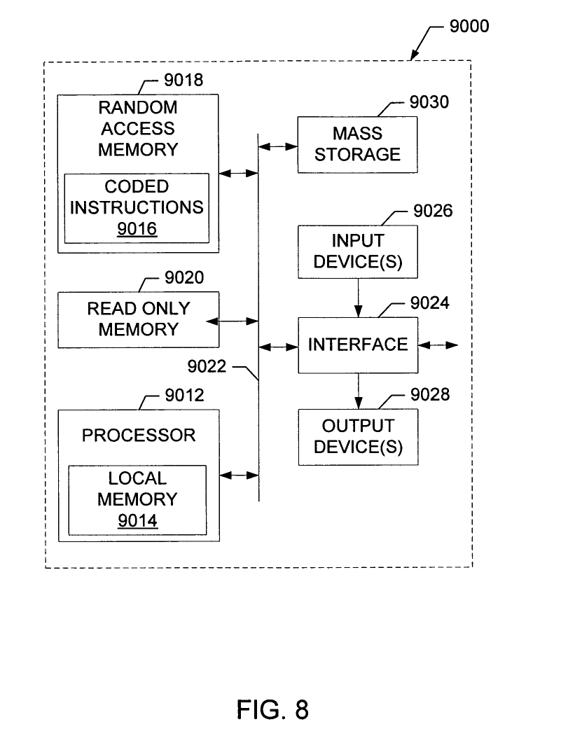

A flowchart representative of example machine readable instructions for implementing the apparatus 100 of FIGS. 1-3 is shown in FIGS. 6-7. In this example, the machine readable instructions comprise a program for execution by a processor such as the processor 9012 shown in the example computer 9000 discussed below in connection with FIG. 8. The program may be embodied in software stored on a tangible medium such as a CD-ROM, a floppy disk, a hard drive, a digital versatile disk (DVD), or a memory associated with the processor 9012, but persons of ordinary skill in the art will readily appreciate that the entire program and/or parts thereof could alternatively be executed by a device other than the processor 9012 and/or embodied in firmware or dedicated hardware in a well known manner. For example, any or all of the first transceiver 202, the receiver 204, the second transceiver 206, the version controller 208, the authenticator 210, the memory 212, and the information handler could be implemented by software, hardware, and/or firmware. Further, although the example program is described with reference to the flowchart illustrated in FIGS. 6-7, persons of ordinary skill in the art will readily appreciate that many other methods of implementing the apparatus 100 may alternatively be used. For example, the order of execution of the blocks may be changed, and/or some of the blocks described may be changed, eliminated, or combined.

FIG. 6 is a flowchart representative of example machine readable instructions which may be executed to authenticate users and receive user input(s) at first apparatus 100 of FIG. 1.

FIG. 6 begins when biometric information is input using the biometric receiver 106 of the apparatus 100 and is received by the receiver 204 and the authenticator 210 of the apparatus 100 (block 502). The biometric information may be any biometric information or any user identification information. The authenticator 210 compares the received biometric information with information stored in the memory 212 (block 504). Based on the comparison, the authenticator 210 determines the identity of the user and further determines if that user is authorized to access the apparatus 100 (block 506). If the user's identity cannot be determined or the user is not authorized to access the apparatus 100, the authenticator 210 returns an error that is displayed to the user via the receiver 204 or the display 103 of the apparatus 100 (block 514). Control then proceeds to block 502 to wait for further user input.

If the user is authorized to access the apparatus 100 (block 506), the authenticator 210 retrieves an identifier associated with the user from the memory 212 and sends it to the information handler 214 (block 508). The information handler 214 then receives user input information (block 510). The user input information may be transferred to the information handler 214 from the first transceiver 202, the receiver 204, the second transceiver 206, and/or any other source of user input information. The information handler 214 then transfers the user input information and the identifier associated with the user to the version controller 208, which stores the user input information with the identifier associated with the user and a time stamp (block 512). Control then returns to block 502 to wait for further user input.

FIG. 6 is a flowchart representative of example machine readable instructions which may be executed to implement the task list 105 of the apparatus 100 of FIG. 1.

FIG. 7 begins when the apparatus 100 receives a task item from a user, a server, or another EW (block 602). For example, a user may write a task item on the first EW 1002 of FIG. 2 and request that it be added to the task list 105. Alternatively, a user at another EW (e.g., the second EW 1018) may write a task item on the other EW and request that it be added to a task list that is shared with the apparatus 100. In another example, a user may enter a task item using a keyboard or remote terminal associated with the apparatus 100.

After receiving the task item, the information handler 214 of the corresponding apparatus 100 determines the priority and/or the deadline date assigned to the task item (block 604). The information handler 214 then inserts the task item in the task list 105 in the proper location based on the priority and/or the deadline date (block 606). The information handler 214 then retrieves the information associated with the first task item in the task list 105 (block 608).

The information handler 214 determines if the deadline for the task item is approaching (block 610). For example, the information handler 214 may compare the number of days or hours remaining until the deadline to a preset value that was previously input by a user. If the comparison indicates that the task item deadline is approaching (block 610), the information handler 214 enables the approaching deadline alert for the task item (block 618). For example, the information handler 214 may set the text of the task item to a different color, may set the task item to be highlighted, may set the task item to blink, may place an identifier next to the task item, etc. may send an email to the team responsible for the task item. Control then proceeds to block 612.

If the information handler 214 determines that the deadline is not approaching (block 610), or after the deadline alert has been executed (block 618), the information handler 214 determines if the task item has been completed (block 612). A user may indicate that the task item has been completed by checking a box, setting a percentage complete value to ‘100%’, indicating a completed date, etc. If the task item has been completed (block 612), the information handler 214 removes the task item from the task list (block 620). Control then proceeds to block 614.

If the task item has not been completed (block 614), or after removing the item from the ask list (block 620), the information handler 214 determines if the task item is a part of a project (block 614). For example, the task item may include an identifier that indicates that the task is a part of a project that includes several tasks that should be grouped together. If the task item is a part of a project (block 614), the information handler 214 enables project identification for the task item (block 622). For example, all task items belonging to a project may be colored the same color, may be grouped together in the task list, may include an identifier to indicate project association, etc. Control then proceeds to block 616.

If the task item is not a part of a project (block 614) or after the information handler 214 enables project identification for the task item (block 622), the information handler then retrieves the information associated with the next task item in the task list 105. If, there are further task items (block 616), control returns to block 610 to configure the task item. If there are no further task items (block 616), the task list update process is completed and terminates.

FIG. 8 is a block diagram of an example computer 9000 capable of executing the machine readable instructions represented by FIGS. 6 and 7 to implement the apparatus and/or methods disclosed herein. The computer 9000 can be, for example, an EW, a server, a personal computer, a personal digital assistant (PDA), an Internet appliance, a set top box, or any other type of computing device. For example, the computer 9000 may be contained in the housing 102 of the apparatus 100 of FIG. 1.

The system 9000 of the instant example includes a processor 9012 such as a general purpose programmable processor. The processor 9012 includes a local memory 9014, and executes coded instructions 9016 present in the local memory 9014 and/or in another memory device. The processor 9012 may execute, among other things, the machine readable instructions illustrated in FIGS. 5 and 6. The processor 9012 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 9012 is in communication with a main memory including a volatile memory 9018 and a non-volatile memory 9020 via a bus 9022. The volatile memory 9018 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 9020 may be implemented by flash memory and/or any other desired type of memory device. Access to the main memory 9018, 9020 is typically controlled by a memory controller (not shown) in a conventional manner.

The computer 9000 also includes a conventional interface circuit 9024. The interface circuit 9024 may be implemented by any type of well known interface standard, such as an Ethernet interface, a universal serial bus (USB), and/or a third generation input/output (3GIO) interface.

One or more input devices 9026 are connected to the interface circuit 9024. The input device(s) 9026 permit a user to enter data and commands into the processor 9012. The input device(s) can be implemented by, for example, a keyboard, a mouse, a touchscreen, a track-pad, a trackball, isopoint and/or a voice recognition system.

One or more output devices 9028 are also connected to the interface circuit 9024. The output devices 9028 can be implemented, for example, by display devices (e.g., a liquid crystal display, a cathode ray tube display (CRT), a printer and/or speakers). The interface circuit 9024, thus, typically includes a graphics driver card.

The interface circuit 9024 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 9000 also includes one or more mass storage devices 9030 for storing software and data. Examples of such mass storage devices 9030 include floppy disk drives, hard drive disks, compact disk drives and digital versatile disk (DVD) drives.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

Although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. An electronic whiteboard comprising:
a housing;
a display in the housing for presenting at least one of stored information or received information;
a memory in the housing to store information associated with the electronic whiteboard; and
an authenticator in the housing to analyze biometric data to identify the user.

2. An electronic whiteboard as defined in claim 1, wherein the authenticator is further to determine if the user is authorized to access the electronic whiteboard.

3. An electronic whiteboard as defined in claim 1, further comprising:
a first input device in the housing to receive information from a user of the electronic whiteboard; and
a second input device associated with the electronic whiteboard to receive the biometric data.

4. An electronic whiteboard as defined in claim 3, further comprising an information handler in the housing to:
receive a task item from at least one of stored information or information received from the first receiver,
generate a task list output; and
send the task list output to the display.

5. An electronic whiteboard as defined in claim 4, the information handler to send the task list output to at least one of a second electronic whiteboard or a server.

6. An electronic whiteboard as defined in claim 3, further comprising a version controller to store information received from the first receiver in the memory and to store a user identifier associated with the biometric data received from the second receiver in the memory.

7. An electronic whiteboard as defined in claim 6, wherein the first receiver receives input from a light emitting writing utensil.

8. An electronic whiteboard as defined in claim 7, wherein the second receiver receives input from a biometric receiver disposed on the light emitting writing utensil.

9. An electronic whiteboard as defined in claim 8, further comprising a wireless transceiver to communicate with the light emitting writing utensil.

10. An electronic whiteboard as defined in claim 1, wherein the display is at least one of an organic light emitting diode (OLED) display, surface-conduction electron-emitter display (SED), an electronic paper display, a liquid crystal display (LCD), a cathode ray tube (CRT), a plasma display, a front projection display, a rear projection display, or a display comprising vacuum deposited organic electronic components.

11. An electronic whiteboard as defined in claim 1, further comprising a transceiver to communicatively link the electronic whiteboard to at least one of a second electronic whiteboard, a computer, or a display device.

12. An electronic whiteboard as defined in claim 1, wherein information associated with user input is stored in the memory as a collection of vectors.

13. An electronic whiteboard as defined in claim 12, wherein the memory stores a timestamp for each of the vectors in the collection of vectors, the timestamps being associated with times at which the respective vectors were generated.

14. An electronic whiteboard as defined in claim 1, wherein the display is further to receive input from a user of the electronic whiteboard.

15. A method for providing a task list on a first electronic whiteboard comprising:
receiving a first task item;
displaying the first task item on the first electronic whiteboard;
comparing a priority of the first task item to a second task item; and
based on the comparison between the first and second task items, at least one of changing a color of text used to display the first or second task items, changing the size of the text used to the display the first or second task items, or causing the display of the first or second task items to blink.

16. (canceled)

17. (canceled)

18. (canceled)

19. (canceled)

20. (canceled)

21. (canceled)

22. (canceled)

23. (canceled)

24. A method comprising:
displaying an image on a first electronic whiteboard;
receiving a change to the image; and
storing a vector associated with the change in a memory associated with the first electronic whiteboard.

25. A method as defined in claim 24, further comprising storing at least one of a timestamp or a user identifier with the vector.

26. A method as defined in claim 24, the change being stored in a database.

27. A method as defined in claim 26, the database comprising a version control system.

28. A method as defined in claim 24, wherein the change is input at the first electronic whiteboard using at least one of a keyboard associated with the first electronic whiteboard, a remote terminal associated with the first electronic whiteboard, or a light emitting writing utensil.

29. A method as defined in claim 24, further comprising transmitting information associated with the change to at least one of a second electronic whiteboard or a server.

30. A method as defined in claim 29, wherein the information is the vector associated with the change.

31. An electronic whiteboard comprising:
a housing;
a receiver associated with the housing to receive first biometric data to identify a user;
a display coupled to the housing to display at least one of a task list or information associated with writing input by the user; and
a memory to store at least one of an item in the task list or the information associated with the writing input by the user and to associate the information associated with the writing input by the user with the identity of the user.

32. An electronic whiteboard as defined in claim 32, the biometric data being at least one of data associated with a fingerprint, a voice, a handprint, facial characteristics, a retina, deoxyribonucleic acid (DNA) sequencing, or handwriting.

33. An electronic whiteboard as defined in claim 32, further comprising an authenticator to analyze the first biometric data and based on the first biometric data to determine if the user is authorized to access the electronic whiteboard.

34. An electronic whiteboard as defined in claim 32, further comprising a first input device in the housing to receive information from a user of the electronic whiteboard.

35. An electronic whiteboard as defined in claim 32, further comprising an information handler in the housing to:
receive a task item from at least one of stored information or information received from the first receiver;
generate a task list output; and
send the task list output to the display.

36. An electronic whiteboard as defined in claim 36, wherein the information handler is to send the task list output to at least one of a second electronic whiteboard or a server.

37. An electronic whiteboard as defined in claim 37, further comprising a version controller to store information received from the first receiver in the memory and to store a user identifier associated with the biometric data received from the second receiver in the memory.

38. An electronic whiteboard as defined in claim 38, wherein the first receiver receives input from a light emitting writing utensil.

39. An electronic whiteboard as defined in claim 39, wherein the second receiver receives input from a biometric receiver disposed on the light emitting writing utensil.

40. An electronic whiteboard as defined in claim 32, further comprising a wireless transceiver to communicate with the light emitting writing utensil.

41. An electronic whiteboard as defined in claim 32, wherein the display is at least one of an organic light emitting diode (OLED) display, surface-conduction electron-emitter display (SED), an electronic paper display, a liquid crystal display (LCD), a cathode ray tube (CRT), a plasma display, a front projection display, a rear projection display, or a display comprising vacuum deposited organic electronic components.

42. An electronic whiteboard as defined in claim 32, further comprising a transceiver to communicatively link the electronic whiteboard to at least one of a second electronic whiteboard, a computer, or a display device.

43. An electronic whiteboard as defined in claim 32, wherein information associated with writing input by the user is stored in the memory as a collection of vectors.

44. An electronic whiteboard as defined in claim 44, wherein the memory stores a timestamp for each of the vectors in the collection of vectors, the timestamps being associated with times at which the respective vectors were generated.

45. An electronic whiteboard as defined in claim 32, wherein the display is further to receive input from a user of the electronic whiteboard.

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)
